(19) United States
(12) Patent Application Publication
(10) Pub. No.: US 2017/0160811 A1
(43) Pub. Date: Jun. 8, 2017

(54) ELECTRONIC DEVICE, CONTROL METHOD, AND STORAGE MEDIUM

(71) Applicant: KYOCERA Corporation, Kyoto-shi, Kyoto (JP)

(72) Inventors: Shigeki TANABE, Yokohama-shi, Kanagawa (JP); Hideki MORITA, Yokohama-shi, Kanagawa (JP); Isao MASUIKE, Machida-shi, Tokyo (JP)

(21) Appl. No.: 15/313,966

(22) PCT Filed: May 28, 2015
(86) PCT No.: PCT/JP2015/065451

§ 371 Date: Nov. 24, 2016

(30) Foreign Application Priority Data
May 28, 2014 (JP) 2014-110629

(51) Int. Cl. G06F 3/01; H04M 3/06; H04M 1/725

(52) U.S. Cl. CPC G06F 3/017; H04M 1/72519; H04M 1/72583; G06F 3/012; G06F 3/013; H04M 1/72597; H04M 3/06

(57) ABSTRACT

A control method according to one aspect of the present disclosure is a control method for controlling an electronic device. The control method includes the steps of performing a notification on an event that occurs, detecting a response operation to the notification, outputting, when the response operation is a single-touch gesture, information on the event in a first method, and outputting, when the response operation is a multi-touch gesture, the information on the event in a second method. The control method according to one aspect of the present disclosure includes causing a smartphone, for example, when the single-touch gesture is detected, to start making a call using a receiver. The control method according to one aspect of the present disclosure includes causing the smartphone, for example, when a multi-touch gesture is detected, to start making a call using a speaker.

### CROSS-REFERENCE TO RELATED APPLICATION

This application is a national stage of PCT International Application No. PCT/JP2015/065451 filed in Japan on May 28, 2015, which claims priority to and incorporates by reference the entire contents of Japanese Patent Application No. 2014-110629 filed in Japan on May 28, 2014.

### FIELD

The present application relates to an electronic device, a control method, and a storage medium.

### BACKGROUND

Electronic devices having a notification function of notifying a user of an event such as an incoming call are known. For example, a device is capable of making a user notice a notification when an incoming call is detected and effectively preventing, for example a response lag to the incoming call by appropriately controlling the notification of the incoming call even if the user is operating.

### SUMMARY

Technical Problem

In one embodiment, an electronic device includes a touch screen configured to accept a single-touch gesture or a multi-touch gesture, and a controller configured to cause a speaker or a display, upon occurrence of an event, to notify first information on the event that occurs. When a predetermined multi-touch gesture is accepted by the touch screen during notification of the occurrence of the event or within a predetermined period of time since the notification of the occurrence, the controller is configured to cause the speaker or the display to notify second information related to the event and different from the first information.

In one embodiment, an electronic device includes a touch screen configured to accept a single-touch gesture or a multi-touch gesture, and a controller configured to control the touch screen so as to enable acceptance of the single-touch gesture and the multi-touch gesture when an incoming voice call occurs. When a predetermined single-touch gesture is accepted by the touch screen during notification of the incoming voice call, the controller is configured to respond to the incoming voice call, and when a predetermined multi-touch gesture is accepted by the touch screen during notification of the incoming voice call, the controller is configured to respond to the incoming voice call.

In one embodiment, an electronic device includes a speaker, a receiver, a touch screen configured to accept a single-touch gesture or a multi-touch gesture, and a controller configured to cause, upon occurrence of an incoming voice call, the incoming voice call that occurs to be notified. When a predetermined single-touch gesture is accepted during notification of the incoming voice call, the controller is configured to start making a call using the receiver, and when a predetermined multi-touch gesture is accepted during notification of the incoming voice call, the controller is configured to start making a call using the speaker.

In one embodiment, a control method for controlling an electronic device includes the steps of performing a notification on an event that occurs, detecting a response operation to the notification, outputting, when the response operation is a single-touch gesture, information on the event in a first method, and outputting, when the response operation is a multi-touch gesture, the information on the event in a second method.

In one embodiment, a non-transitory computer readable recording medium configured to store a control data for causing an electronic device to execute the steps of performing a notification on an event that occurs, detecting a response operation to the notification, outputting, when the response operation is a single-touch gesture, information on the event in a first method, and outputting, when the response operation is a multi-touch gesture, the information on the event in a second method.

### BRIEF DESCRIPTION OF THE DRAWINGS

FIG. 1 is a perspective view of a smartphone according to some embodiments.

FIG. 2 is a front view of the smartphone.

FIG. 3 is a back view of the smartphone.

FIG. 4 is a block diagram of the smartphone.

FIG. 5 is a diagram illustrating an example of a notification operation upon an incoming call.

FIG. 6 is a flowchart illustrating an example of the notification operation of the smartphone.

### DETAILED DESCRIPTION

A plurality of embodiments will be explained in detail with reference to the accompanying drawings. A smartphone will be explained below as an example of the electronic device having a notification function.

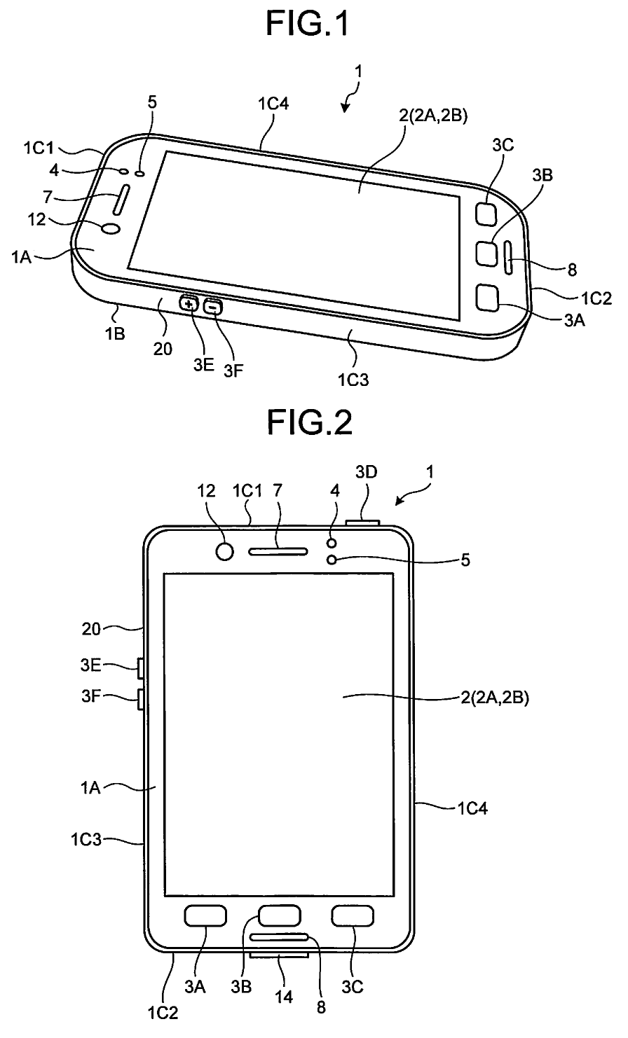

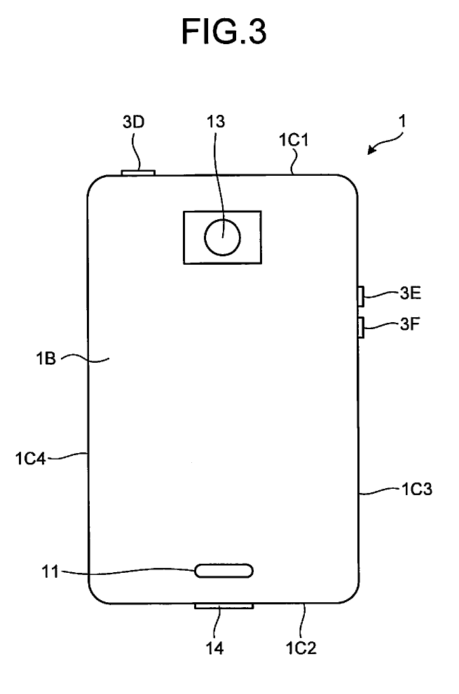

The overall configuration of a smartphone 1 according to the embodiments will be explained with reference to FIG. 1 to FIG. 3. The smartphone 1 includes a housing 20. The housing 20 includes a front face 1A, a back face 1B, and side faces 1C1 to 1C4. The front face 1A is a front of the housing 20. The back face 1B is a back of the housing 20. The side faces 1C1 to 1C4 are sides each connecting the front face 1A and the back face 1B. Hereinafter, the side faces 1C1 to 1C4 may be collectively called “side face 1C” without being specific to any of the side faces.

The smartphone 1 has a touch screen display 2, buttons 3A to 3C, an illumination sensor 4, a proximity sensor 5, a receiver 7, a microphone 8, and a camera 12, which are provided in the front face 1A. The smartphone 1 has a speaker 11 and a camera 13 provided in the back face 1B. The smartphone 1 has buttons 3D to 3F and a connector 14, which are provided in the side face 1C. Hereinafter, the buttons 3A to 3F may be collectively called “button 3” without being specific to any of the buttons.

The touch screen display 2 includes a display 2A and a touch screen 2B. In the example of FIG. 1, although each of the display 2A and the touch screen 2B is substantially rectangular-shaped, the shape of the display 2A and the touch screen 2B is not limited thereto. The display 2A and the touch screen 2B can be any shape such as a square or a circle. In the example of FIG. 1, although the display 2A and the touch screen 2B are arranged in a superimposed manner, the arrangement of the display 2A and the touch screen 2B is not limited thereto. The display 2A and the touch screen 2B may be arranged, for example, side by side or apart from each other. In the example of FIG. 1, although longer sides of the display 2A are parallel to longer sides of the touch screen 2B respectively and shorter sides of the display 2A are parallel to shorter sides of the touch screen 2B respectively, the manner in which the display 2A and the touch screen 2B are superimposed is not limited thereto. If the display 2A and the touch screen 2B are arranged in the superimposed manner, for example, one or more sides of the display 2A may not be parallel to any of the sides of the touch screen 2B.

The display 2A can display an object. The object includes texts, images, symbols, graphics, and the like. The display 2A includes a display device. The display device includes an LCD (Liquid Crystal Display), an OELD (Organic Electro-Luminescence Display), or an IELD (Inorganic Electro-Luminescence Display).

The touch screen 2B can detect a contact of a finger, a pen, a stylus pen, or the like on the touch screen 2B. The touch screen 2B can detect positions where a plurality of fingers, pens, stylus pens, or the like make contact with the touch screen 2B. In the following explanation, the finger, the pen, the stylus pen, or the like that is in contact with the touch screen 2B may be called simply “finger”, “contact object”, or “contact thing”.

The detection method of the touch screen 2B can adopt a plurality of methods. The methods include a capacitive type detection method, a resistive type detection method, a surface acoustic wave type (or ultrasonic type) detection method, an infrared type detection method, an electromagnetic induction type detection method, and a load sensing type detection method, and the like. In the description herein below, for the sake of its simplicity, although it is assumed that a user uses his/her finger(s) to make contact with the touch screen 2B in order to operate the smartphone 1, the embodiments are not limited thereto.

The smartphone 1 determines a type of a gesture based on at least one of an existence of a contact detected by the touch screen 2B, the number of contact objects where contacts are detected, a position where the contact is detected, a change in the position where the contact is detected, an interval at which the contact is detected, the time during which detection of the contact is continued, and the number of times when the contact is detected. The gesture is an operation performed on the touch screen 2B. Examples of the gesture determined by the smartphone 1 include, but are not limited to, touch, long touch, release, swipe, tap, double tap, long tap, multi-tap, drag, flick, pinch, and spread.

“Touch” is a gesture in which a finger makes contact with the touch screen 2B. The smartphone 1 may determine a gesture in which the finger makes contact with the touch screen 2B as touch. “Long touch” is a gesture in which a finger makes contact with the touch screen 2B for longer than a given time. The smartphone 1 may determine a gesture in which the finger makes contact with the touch screen 2B for longer than a given time as long touch.

“Release” is a gesture in which a finger separates from the touch screen 2B. The smartphone 1 may determine a gesture in which the finger separates from the touch screen 2B as release. “Swipe” is a gesture in which a finger moves on the touch screen 2B with continuous contact thereon. The smartphone 1 may determine a gesture in which the finger moves on the touch screen 2B with continuous contact thereon as swipe.

“Tap” is a gesture in which a touch is followed by a release. The smartphone 1 may determine a gesture in which a touch is followed by a release as tap. “Double tap” is a gesture such that a gesture in which a touch is followed by a release is successively performed twice. The smartphone 1 may determine a gesture, such that a gesture in which a touch is followed by a release is successively performed twice, as double tap.

“Long tap” is a gesture in which a long touch is followed by a release. The smartphone 1 may determine a gesture in which a long touch is followed by a release as long tap. “Multi-tap” is a tap gesture with a plurality of fingers. The smartphone 1 may determine a tap gesture with a plurality of fingers as multi-tap. “Drag” is a gesture in which a swipe is performed from a starting point in an area where a movable-object is displayed. The smartphone 1 may determine a gesture in which a swipe is performed from a starting point in an area where the movable-object is displayed as drag.

“Flick” is a gesture in which a finger separates from the touch screen 2B while moving after making contact with the touch screen 2B. That is, “flick” is a gesture in which a touch is followed by a release accompanied with a movement of the finger. The smartphone 1 may determine a gesture in which the finger separates from the touch screen 2B while moving after making contact with the touch screen 2B as flick. The flick is performed, in many cases, with a finger moving along one direction. The flick includes “upward flick” in which the finger moves upward on the screen, “downward flick” in which the finger moves downward on the screen, “rightward flick” in which the finger moves rightward on the screen, and “leftward flick” in which the finger moves leftward on the screen, and the like. Movement of the finger during the flick is, in many cases, quicker than that of the finger during the swipe.

“Pinch” is a gesture in which a swipe with a plurality of fingers is performed in a direction to move the fingers toward each other. The smartphone 1 may determine a gesture in which the distance between a position of one finger and a position of another finger detected by the touch screen 2B becomes shorter as pinch. “Pinch” may be called pinch in. “Spread” is a gesture in which a swipe with a plurality of fingers is performed in a direction to move the fingers away from each other. The smartphone 1 may determine a gesture in which the distance between a position of one finger and a position of another finger detected by the touch screen 2B becomes longer as spread. “Spread” may be called pinch out.

In the description herein below, a gesture performed by using a single finger may be called a “single-touch gesture”, and a gesture performed by using a plurality of fingers may be called a “multi-touch gesture”. The multi-touch gesture includes, for example, a pinch and a spread. A tap, a flick, or a swipe or the like is a single-touch gesture when performed by using a single finger, and is a multi-touch gesture when performed by using a plurality of fingers.

The smartphone 1 is capable of performing operations according to these gestures which are determined through the touch screen 2B. The smartphone 1 achieves user-friendly and intuitive operability. The operations performed by the smartphone 1 according to the determined gestures may be different depending on the screen displayed on the display 2A. In the following explanation, for the sake of its simplicity, the fact that the touch screen 2B detects the contact(s) and then the smartphone 1 determines the type of the gesture as X based on the detected contact(s) may be described as “the smartphone 1 detects X” or “a controller 10 detects X”.

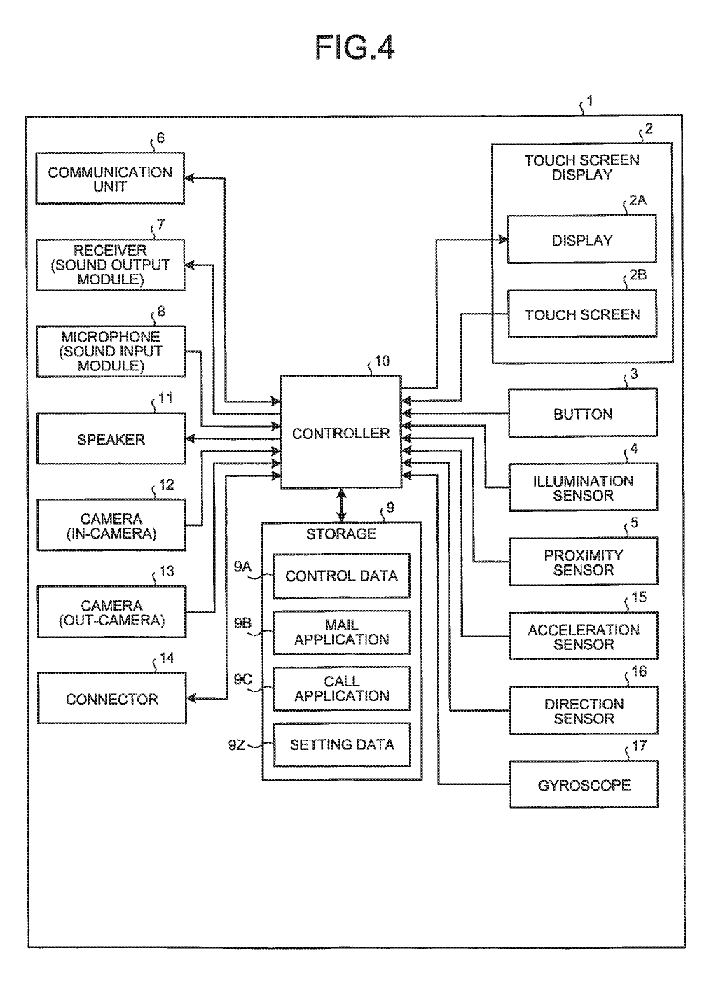

FIG. 4 is a block diagram of the smartphone 1. The smartphone 1 includes the touch screen display 2, the button 3, the illumination sensor 4, the proximity sensor 5, a communication unit 6, the receiver 7, the microphone 8, a storage 9, the controller 10, the speaker 11, the cameras 12 and 13, the connector 14, an acceleration sensor 15, a direction sensor 16, and a gyroscope 17.

The touch screen display 2 includes the display 2A and the touch screen 2B. The display 2A can display objects such as texts, images, symbols, or graphics. The touch screen 2B can detect contact(s) by contact thing(s). The controller 10 can detect a gesture performed on the smartphone 1. Specifically, the controller 10 can detect a gesture for the touch screen 2B (or the touch screen display 2) as a user operation in cooperation with the touch screen 2B.

The button 3 is operated by the user. The button 3 includes a button 3A to a button 3F. The controller 10 can detect an operation for the button 3 in cooperation with the button 3. Examples of the operations for the button 3 include, but are not limited to, a click, a double click, a triple click, a push, and a multi-push.

The buttons 3A to 3C are, for example, a home button, a back button, or a menu button. The button 3D is, for example, a power on/off button of the smartphone 1. The button 3D may function also as a sleep/sleep release button. The buttons 3E and 3F are, for example, volume buttons.

The illumination sensor 4 can detect illumination of the ambient light of the smartphone 1. The illumination indicates intensity of light, lightness, or brightness. The illumination sensor 4 may be used, for example, to adjust the brightness of the display 2A. The proximity sensor 5 can detect the presence of a nearby object without any contact. The proximity sensor 5 detects the presence of an object based on a change of the magnetic field, a change of the return time of the reflected ultrasonic wave, etc. The proximity sensor 5 may be used to detect that, for example, the touch screen display 2 is brought close to someone's face. The illumination sensor 4 and the proximity sensor 5 may be configured as one sensor. The illumination sensor 4 can be used as a proximity sensor.

The communication unit 6 can perform wireless communication. The communication unit 6 can support a communication method based on a wireless communication standard. The wireless communication standard includes, for example, a cellular-phone communication standard such as 2G, 3G, and 4G. The cellular-phone communication standard includes, for example, LTE (Long Term Evolution), W-CDMA (Wideband Code Division Multiple Access), CDMA 2000, PDC (Personal Digital Cellular), GSM (registered trademark) (Global System for Mobile Communications), and PHS (Personal Handy-phone System). The wireless communication standard further includes, for example, WiMAX (registered trademark) (Worldwide Interoperability for Microwave Access), IEEE 802.11, Bluetooth (registered trademark), IrDA (Infrared Data Association), and NFC (Near Field Communication). The communication unit 6 may support one or more of the communication standards described above. The communication unit 6 may support wired communication. The wired communication includes, for example, Ethernet (registered trademark) and a fiber channel.

The receiver 7 and the speaker 11 may be sound output modules. The receiver 7 and the speaker 11 can receive a sound signal transmitted from the controller 10. The receiver 7 and the speaker 11 can output the received sound signal as sound. The receiver 7 is used, for example, to output the other party's voice during a call. The speaker 11 is used, for example, to output a ringtone and music. Either one of the receiver 7 and the speaker 11 may double as the other function. The microphone 8 may be a sound input module. The microphone 8 can convert a user's voice or the like to a sound signal. The microphone 8 can transmit the converted sound signal to the controller 10.

The storage 9 can store data. The storage 9 is used also as a work area that temporarily stores a processing result of the controller 10. The storage 9 may include any non-transitory storage medium such as a semiconductor storage medium and a magnetic storage medium. The storage 9 may include a plurality of types of storage mediums. The storage 9 may include a combination of a portable storage medium with a reading device of the storage medium. The storage 9 may include a storage device used as a temporary storage area such as RAM (Random Access Memory). The portable storage medium includes a memory card, an optical disk, or a magneto-optical disk, and so on.

Data stored in the storage 9 includes applications executed in the foreground or the background and a control data for assisting operations of the applications. The application causes, for example, the display 2A to display a screen. The application causes the controller 10 to perform processing according to, for example, a gesture detected through the touch screen 2B. The control data is, for example, an OS. The applications and the control data may be installed into the storage 9 through communication by the communication unit 6 or through a non-transitory storage medium.

The storage 9 may store, for example, a control data 9A, a mail application 9B, a call application 9C, and setting data 9Z. The mail application 9B can provide an e-mail function for compositing, transmitting, receiving, displaying e-mails, and the like. The call application 9C can provide a call function for outgoing and incoming calls. The setting data 9Z includes information on various settings related to the operations of the smartphone 1.

The control data 9A can provide a function related to various controls for operating the smartphone 1. The function provided by the control data 9A includes a notification function for notifying the user of information on various events that occur. Examples of the events to be notified by the notification function include, but are not limited to, an incoming call (incoming voice call), an incoming message such as mail, arrival of a start time for a registered schedule, arrival of a registered wake-up time, and notification of application update. The function provided by the control data 9A may be used in combination with functions provided by other data such as the mail application 9B and the call application 9C.

The controller 10 can integrally control the operations of the smartphone 1. The controller 10 implements various functions. The controller 10 includes a processor. Examples of the processor include, but are not limited to, a CPU (Central Processing Unit), an SoC (System-on-a-chip), an MCU (Micro Control Unit), and an FPGA (Field-Programmable Gate Array). Some other components such as the communication unit 6 may be integrated into the SoC.

Specifically, the controller 10 can execute instructions included in the data stored in the storage 9 while referring to the data stored in the storage 9 as necessary. The controller 10 then controls a function module according to the data and the instructions to thereby enable implementation of the various functions. Examples of the function module include, but are not limited to, the display 2A, the communication unit 6, the receiver 7, and the speaker 11. The controller 10 can change the control according to the detection result of a detector. Examples of the detector include, but are not limited to, the touch screen 2B, the button 3, the illumination sensor 4, the proximity sensor 5, the microphone 8, the camera 12, the camera 13, the acceleration sensor 15, the direction sensor 16, and the gyroscope 17.

The controller 10 executes, for example, the control data 9A, and can thereby perform the various controls such as notifying the user of the information on an event that occurs. The controller 10 can notify the user of the information by using any one of sound, light, and vibration, etc.

The camera 12 may capture an object facing the front face 1A, as an in-camera. The camera 13 may capture an object facing the back face 1B, as an out-camera.

The connector 14 includes a terminal to which other device is connected. The connector 14 may be a general-purpose terminal such as a USB (Universal Serial Bus), an HDMI (registered trademark) (High-Definition Multimedia Interface), Light Peak, Thunderbolt (registered trademark), an MHL (Mobile High-definition Link), a LAN connector (Local Area Network connector), and an earphone/microphone connector. The connector 14 may be a dedicated terminal such as a Dock connector. Examples of the device connected to the connector 14 include, but are not limited to, an external storage, a speaker, and a communication device.

The acceleration sensor 15 can detect a direction and a magnitude of acceleration applied to the smartphone 1. The direction sensor 16 can detect a direction of the geomagnetism. The gyroscope 17 can detect an angle and an angular velocity of the smartphone 1. The detection results of the acceleration sensor 15, the direction sensor 16, and the gyroscope 17 may be used in combination with each other in order to detect a position of the smartphone 1 and a change of its attitude.

Part or all of the data stored in the storage 9 may be downloaded from any other device through communication by the communication unit 6. Part or all of the data stored in the storage 9 may be stored in a non-transitory storage medium that can be read by a reading device included in the storage 9. Part or all of the data stored in the storage 9 may be stored in a non-transitory storage medium that can be read by a reading device connected to the connector 14. Examples of the non-transitory storage mediums include, but are not limited to, an optical disk such as CD (registered trademark), DVD (registered trademark), and Blu-ray (registered trademark), a magneto-optical disk, magnetic storage medium, a memory card, and a solid-state storage medium.

The configuration of the smartphone 1 illustrated in FIG. 4 is only an example, and therefore it can be modified as required within a scope that does not depart from the gist of the present application. For example, the number and the type of the button 3 are not limited to the example of FIG. 4. The smartphone 1 may be provided with buttons in a numeric keypad layout, or QWERTY layout, or the like as buttons for screen operations, instead of the buttons 3A to 3C. The smartphone 1 may be provided with only one button for screen operations, or with no button. In the example illustrated in FIG. 4, although the smartphone 1 is provided with two cameras, the smartphone 1 may be provided with only one camera or with no camera. In the example of FIG. 4, although the smartphone 1 is provided with three types of sensors in order to detect its position and attitude, the smartphone 1 may not be provided with some of the sensors. Alternatively, the smartphone 1 may be provided with any other type of sensor for detecting at least one of the position and the attitude.

The basic configuration of the smartphone 1 according to the present embodiment has been explained so far. An example of a notification operation that the smartphone 1 according to the embodiments notifies the user of information on an event that occurs will be explained below.

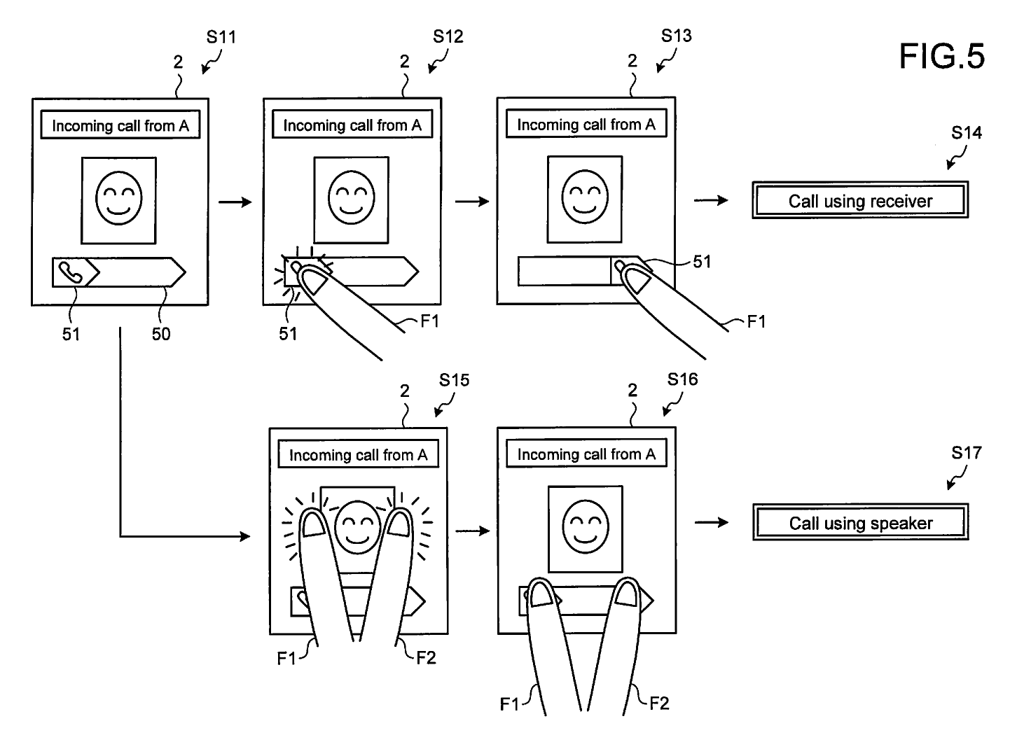

FIG. 5 is a diagram illustrating an example of a notification operation upon an incoming call. When detecting an incoming call, the smartphone 1 displays an incoming call screen on the touch screen display 2 (display 2A) as illustrated at Step S11.

The incoming call screen as illustrated in FIG. 5 includes a slider 50 in its lower part. An icon 51 with an image of a receiver is displayed at the left edge of the slider 50. The smartphone 1 notifies the user of an incoming call even in any method previously selected by the user such as outputting of a ringtone or music from the speaker 11, lighting of a lamp, or vibration of a vibrator, in addition to the display of the incoming call screen.

At Step S12, the user brings a finger F1 into contact with the touch screen display 2 within a display area of the icon 51. At Step S13, the user moves the contact position to the right edge of the slider 50 while contacting the finger F1 contacted at Step S12 on the touch screen display 2. The smartphone 1 moves the icon 51 according to the movement of the contact position.

When detecting such a single-touch gesture, then at Step S14, the smartphone 1 starts making a call using the receiver 7. That is, the smartphone 1 starts processing of outputting voice transmitted from a device of the other party from the receiver 7 and of transmitting voice acquired by the microphone 8 to the device of the other party. In this case, the user of the smartphone 1 holds the smartphone 1 in such a manner that the receiver 7 is located near his/her ear, and talks. The single-touch gesture is set on the assumption that, for example, the user operates while looking at the display 2A. The single-touch gesture may include at least one of a contact start position, a route of the finger moving with continuous contact, and a contact release position, as a condition.

The user can perform other operation on the smartphone 1 to respond to the incoming call. At Step S15, the user brings the finger F1 and a finger F2 into contact with the touch screen display 2 while the notification started at Step S11 is continued. In FIG. 5, although the contact positions of the fingers F1 and F2 are outside the slider 50, the positions are not limited thereto. At Step S16, the contact positions are moved downward while the fingers F1 and F2 brought into contact with the touch screen display 2 at Step S15 are in contact therewith continuously. In FIG. 5, although the contact positions of the fingers F1 and F2 are moved downward, the movement is not limited thereto. The fingers F1 and F2 may be moved toward each other, or moved away from each other. The fingers F1 and F2 may move upward, leftward, or rightward, or need not move.

When detecting the multi-touch gesture, then at Step S17, the smartphone 1 starts making a call using the speaker 11. That is, the smartphone 1 starts the processing of outputting voice transmitted from the device of the other party from the speaker 11 and of transmitting voice acquired by the microphone 8 to the device of the other party. In this case, the user of the smartphone 1 can make a call even if the receiver 7 is not located near his/her ear. The multi-touch gesture is a different gesture from the single-touch gesture described above. The multi-touch gesture is set on the assumption that, for example, the user operates without looking at the display 2A. The multi-touch gesture may not include the contact start position, the route of the finger moving with continuous contact, and the contact release position, as a condition.

In this way, the smartphone 1 can accept two types of response operations for the notified incoming call event. The response operation is an operation that the user having noticed the notification of the event performs on the smartphone 1 in order to acquire further information on the event.

As illustrated at Step S12 to Step S13, one of the response operations is an operation for bringing a single finger into contact with the touch screen display 2 at the left edge of the slider 50 and moving the contact position up to the right edge of the slider 50 with continuous contact thereon. The single-touch gesture that limits the operation position is not likely to be accurately performed unless the user performs the operation while looking at the touch screen display 2. When the single-touch gesture that limits the operation position is detected, the user is more likely to freely operate the smartphone 1. As illustrated at Step S14, the smartphone 1 starts making a call in a method that the contents of the call are hard to be known to the third party although there is a limit in the way to hold the smartphone 1.

The other one of the response operation is an operation, as illustrated at Step S15 to Step S16, that is performed by contacting the touch screen display 2 with a plurality of fingers at arbitrary positions. The multi-touch gesture at the arbitrary positions is executable even without watching the touch screen display 2 carefully. When the multi-touch gesture at the arbitrary positions is detected, the user is likely not to freely operate the smartphone 1. As illustrated at Step S17, although the contents of the call are likely to be known to the third party, the smartphone 1 starts making a call in a method that there is no limit to hold the smartphone 1.

The two response operations are effective also for preventing malfunction. In the case of the single-touch gesture that limits the operation position, it is very unlikely to be detected as malfunction unless the user intentionally performs the operation. Also, in the case of the multi-touch gesture at the arbitrary positions, it is hard to be detected as malfunction by limiting the type of the multi-touch gesture unless the user intentionally performs the operation. For example, by limiting the multi-touch gesture to a pinch, a spread, or a swipe in which a plurality of contact positions are moving in parallel, the possibility of detecting the response operation although the user does not intentionally perform the operation can be reduced.

As explained above, the smartphone 1 accepts the two types of operations such as the single-touch gesture at a predetermined position and the multi-touch gesture at arbitrary positions, as a response operation to start providing further information on the notified event. The smartphone 1 then starts providing further information on the notified event in a method suitable for the user's status according to the type of the accepted operation.

Although the example of the notification operation on the event of an incoming voice call has been explained in FIG. 5, the smartphone 1 accepts the two types of response operations as explained above also for a notification operation on other events.

For example, a notification operation for an incoming mail event is performed in the following manner. When a single-touch gesture is detected at a predetermined position during notification for an incoming mail or after completion of the notification, the smartphone 1 displays contents of the mail on the touch screen display 2. On the other hand, when a multi-touch gesture is detected at arbitrary positions during notification for an incoming mail or after completion of the notification, the smartphone 1 converts the contents of the mail to voice through text-to-speech processing and outputs the voice from the speaker 11. The contents of the mail output as voice may include at least one of its subject, sender, and body.

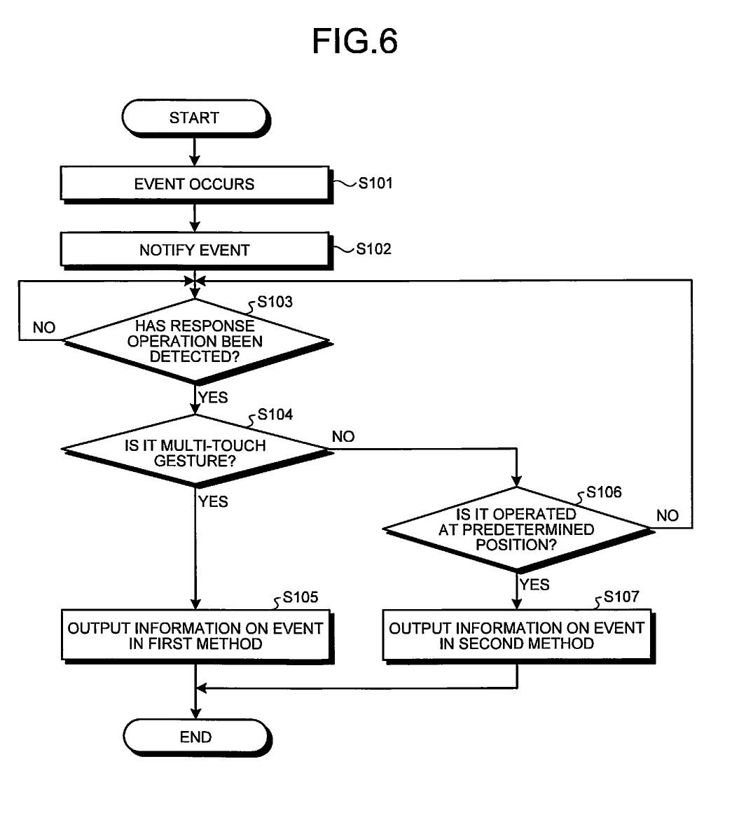

More details of the notification operation of the smartphone 1 will be explained below with reference to FIG. 6. FIG. 6 is a flowchart illustrating an example of the notification operation of the smartphone 1. The operations illustrated in FIG. 6 are implemented by the controller 10 executing the control data 9A. The procedure illustrated in FIG. 6 is executed when an event that needs notification occurs while the controller 10 is executing various applications such as the mail application 9B and the call application 9C. The controller 10 may end the operations illustrated in FIG. 6 after the end of the notification or after the elapse of a predetermined time period since the end of the notification. The controller 10 sometimes executes other operations in parallel with the operations illustrated in FIG. 6.

When an event that needs notification occurs at Step S101, the controller 10 performs notification of the event at Step S102.

At Step S103, the controller 10 determines whether a response operation corresponding to the notification has been detected during execution of the notification or after the end of the notification. When the response operation has not been detected (No at Step S103), the controller 10 performs again the determination of Step S103. When the response operation has been detected (Yes at Step S103), the controller 10 proceeds to Step S104.

At Step S104, the controller 10 determines whether the detected response operation is a multi-touch gesture. When the detected response operation is a multi-touch gesture (Yes at Step S104), the controller 10 proceeds to Step S105. At Step S105, the controller 10 outputs the information on the notified event in a first method.

The first method is an appropriate method when the user is not likely to freely operate the smartphone 1. The first method includes a method of outputting information as voice from the speaker 11, or the like.

When the detected response operation is not the multi-touch gesture, i.e., when the detected response operation is the single-touch gesture (No at Step S104), the controller 10 proceeds to Step S106. At Step S106, the controller 10 determines whether the detected single-touch gesture is operated at the predetermined position. When the detected single-touch gesture is not operated at the predetermined position (No at Step S106), the controller 10 returns to Step S103.

When the single-touch gesture is operated at the predetermined position (Yes at Step S106), the controller 10 proceeds to Step S107. At Step S107, the controller 10 outputs the information on the notified event in a second method.

The second method is an appropriate method when the user can freely operate the smartphone 1. The second method includes a method of outputting information as voice from the receiver 7 and a method of displaying information on the display 2A, and so on.

The embodiments disclosed in the present application can be modified within a scope that does not depart from the gist and the scope of the present application. Moreover, the embodiments and modifications thereof disclosed in the present application can be combined with each other if necessary. For example, the embodiments may be modified as follows.

For example, the data illustrated in FIG. 4 may be divided into a plurality of modules. Alternatively, the data illustrated in FIG. 4 may be combined with the other data.

In the embodiments, although the smartphone has been explained as an example of the electronic device including the notification function, the device according to the appended claims is not limited to the smartphone. The device according to the appended claims may be a mobile electronic device other than the smartphone. Examples of the mobile electronic devices include, but are not limited to, mobile phones, tablets, mobile personal computers, digital cameras, media players, electronic book readers, navigators, and gaming devices. The device according to the appended claims may be a stationary-type electronic device. Examples of the stationary-type electronic device include, but are not limited to, desktop personal computers and television receivers.

Although the art of appended claims has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

In the present application, descriptions such as “when”, “during”, “if”, “in a case”, “upon”, “in response to determining”, and “in response to detecting” may be understood in place of other descriptions depending on situations. In the present application, descriptions such as “when ‘a stated condition or event’ is determined”, “when ‘a stated condition or event’ is detected”, or “upon determining ‘a stated condition or event’”, “in response to determining”, “upon detecting”, or “in response to detecting” may be understood in place of other descriptions depending on situations. In the present application, a description such as “detect” may be understood as meaning of “measure”, “scale”, and “sense” depending on situations.

An improvement of a method of making the user notice the notification has been considered, but an improvement of a method of responding to the event after the user notices the notification has not been considered.

1. An electronic device comprising:
a touch screen configured to accept a single-touch gesture or a multi-touch gesture; and
a controller configured to cause a speaker or a display, upon occurrence of an event, to notify first information on the event that occurs, wherein,
when a predetermined multi-touch gesture is accepted by the touch screen during notification of the occurrence of the event or within a predetermined period of time since the notification of the occurrence,
the controller is configured to cause the speaker or the display to notify second information related to the event and different from the first information.

2. The electronic device according to claim 1, wherein the event includes an incoming mail.

3. The electronic device according to claim 2, wherein,
when receiving the mail,
the controller is configured to cause the speaker or the display to notify reception of the mail as the first information, and
when the predetermined multi-touch gesture is accepted during notification of the reception of the mail or within a predetermined period of time since the notification,
the controller is configured to cause the speaker to read aloud contents of the mail as voice.

4. The electronic device according to claim 3, wherein,
when a predetermined single-touch gesture is accepted by the touch screen during notification of the reception of the mail or within the predetermined period of time since the notification,
the controller is configured to cause the display to display the contents of the mail.

5. An electronic device comprising:
a touch screen configured to accept a single-touch gesture or a multi-touch gesture; and
a controller configured to control the touch screen so as to enable acceptance of the single-touch gesture and the multi-touch gesture when an incoming voice call occurs, wherein,
when a predetermined single-touch gesture is accepted by the touch screen during notification of the incoming voice call,
the controller is configured to respond to the incoming voice call, and
when a predetermined multi-touch gesture is accepted by the touch screen during notification of the incoming voice call,
the controller is configured to respond to the incoming voice call.

6. The electronic device according to claim 5, wherein the controller is configured to respond to the incoming voice call irrespective of contact positions of the multi-touch gesture.

7. The electronic device according to claim 5, wherein the predetermined single-touch gesture is configured to include at least one of a contact start position, a route of a finger moving with continuous contact, and a contact release position, as a condition.

8. (canceled)

9. A control method for controlling an electronic device, the control method comprising the steps of:
performing a notification on an event that occurs;
detecting a response operation to the notification;
outputting, when the response operation is a single-touch gesture, information on the event in a first method; and
outputting, when the response operation is a multi-touch gesture, the information on the event in a second method.

10. (canceled)
